(19) United States
(12) Patent Application Publication
(10) Pub. No.: US 2025/0229143 A1
(43) Pub. Date: Jul. 17, 2025

(54) ADJUSTABLE GOLF CLUB HOSEL AND SHAFT SYSTEM

(71) Applicant: Ryynstal, LLC, Prosper, TX (US)

(72) Inventor: Daniel J. Lee, Prosper, TX (US)

(21) Appl. No.: 19/172,388

(22) Filed: Apr. 7, 2025

Related U.S. Application Data
(63) Continuation of application No. PCT/US2023/032708, filed on Sep. 14, 2023.
(60) Provisional application No. 63/416,098, filed on Oct. 14, 2022.

(51) Int. Cl. A63B 53/02

(52) U.S. Cl. CPC A63B 53/025; A63B 53/026

(57) ABSTRACT

A fixation assembly is provided for fixing a golf club shaft to a golf club head. The assembly includes a first bore integrated into the golf club head, the first bore having a first orientation fixation feature and a first axis of symmetry. The assembly also includes an adapter ring having an inner second bore and a second orientation fixation feature for mating with the first orientation fixation feature to fix an orientation of the adapter ring relative to the first bore. The second bore has a second axis of symmetry, and when the second orientation fixation feature is mated with the first orientation fixation feature, the first axis of symmetry is not colinear or parallel with the second axis of symmetry. Also provided is a system for fixing a golf club shaft to a golf club head.

### CROSS REFERENCE TO RELATED APPLICATIONS

This application is a continuation of International Application No.: PCT/US2023/032708, filed Sep. 14, 2023, which takes priority from Provisional Patent Application No. 63/416,098, filed Oct. 14, 2022, the contents of each of which are incorporated by reference herein.

### FIELD OF THE INVENTION

The present disclosure relates generally to sports equipment, specifically relating to golf clubs, and more specifically, golf club head angle adjustment relative to a shaft main axis.

### BACKGROUND

It is understood in golf that changing the relative angle between club head and shaft will alter the key performance parameters of loft, lie, and face angles. There are a number of interconnection systems on the market which allow a user to change these parameters. However, many of these existing systems suffer from user confusion as a result of having an excessive number of possible combinations as well as being visually complicated. In addition, these existing systems often rely on the rotational movement of the shaft and grip to afford all the possible combinations inherent in their designs. This required shaft rotation effectively limits these systems' benefit in the case of putters or grips with orientation features, where maintaining grip rotational orientation with respect to the head is desired.

There is a need for a connection system which is more optimal in terms of clarity and convenience—made easier to understand by limiting the number of effective combinations, having simpler operation, a simpler appearance, and having the ability to maintain grip orientation.

### SUMMARY

The present disclosure relates to a shaft to head adjustable golf club system comprised of a head including a hosel receptacle (either directly in the head or in a neck), and a shaft including a grip and a sleeve tip assembly consisting of a sleeve part and a ring part. In embodiments, the sleeve part has an internal shaft bore feature at the top (proximal) end, external radial interlocking cog features in the middle portion, and a threaded bore at the tip (distal) end. Cog features are spline-like features which prevent rotational movement between mated elements. The ring part, which is sub-assembled to the sleeve part, has the inverted mating cog features on its proximal inner ring surface and is configured to mate with the sleeve part. The external distal ring surface has a second set of cog features whose rotational axis of symmetry is neither colinear or parallel to the rotational axis of symmetry of the rings inner cog features. The difference in angle between the inner and outer axes of rotational symmetry of the ring represent a “tilt” axis which is effectively the primary angle of adjustment for the system of the present invention. The external distal cog features of the ring may mate into a second inverted mating set of cog features present in the hosel.

In order to simplify the appearance, unlike some current art adjustment interfaces on the market, in many embodiments, the interlocking cog elements of the present invention are concealed when assembled. This may be accomplished by having the cog protrusions on both the sleeve and on the distal end of the ring, be nested into their respective mating depressions of the ring and hosel respectively. In such embodiments, the cogs are more akin to a ring gear-like radial meshing rather than face gear-like meshing of teeth. As a result, upon assembly, the interfaces of adjacent elements, in the present invention, appear as a straight line rather than jagged steps.

In some embodiments, the ring is retained on the sleeve sub-assembly by means of a radial snap fit as an inner rim of the ring passes over a partial or full circumferential rim on the sleeve during factory assembly. In some embodiments, the retaining element may be a separate part as in a retaining ring, clip, pin, or swaged element.

The number of equal-angularly spaced indexed positions for the first upper (proximal) set of cog mating features, and the second lower (distal) set of cog mating features may be equal in number. In some embodiments, such as that shown, this number is (but not limited to) 4. Having an equal number of proximal and distal indexed positions affords maintaining a fixed rotational grip orientation.

The hosel feature may reside on a separate part or be integral directly within the head or neck components. In the case of a club with a discernable neck feature, the neck itself may be a separate component or integral to the head. If the neck is separate, the preferred embodiment of the neck to head interface, in a putter club, is a circular taper lock with a threaded end. This smooth locking taper interface affords 1 additional degree of freedom adjustment for face angles, and relies on frictional locking forces to prevent rotational movement.

All parts of the present invention adjustment system, may be mass fabricated in any material including (and not limited to) aluminum, titanium, stainless and alloy steels, brass, nickel, ceramics, and resins (both thermoplastic and thermoset), and any combination of means including (and not limited to) forging, casting, molding, machining, extruding, printing and additive manufacturing.

In some embodiments, the fixation assembly for fixing a golf club shaft to a golf club head includes a first bore integrated into the golf club head, the first bore having a first orientation fixation feature and a first axis of symmetry, and an adapter ring having an inner second bore and a second orientation fixation feature for mating with the first orientation fixation feature to fix an orientation of the adapter ring relative to the first bore. The second bore has a second axis of symmetry, and when the second orientation fixation feature is mated with the first orientation fixation feature, the first axis of symmetry is not colinear or parallel with the second axis of symmetry.

In some embodiments, the first orientation fixation feature and the second orientation fixation feature mate in one of a plurality of discrete potential orientations. Each of the discrete potential orientations then defines a different relationship between the first axis of symmetry and the second axis of symmetry.

In some such embodiments, in each of the discrete orientations, the first axis of symmetry and the second axis of symmetry define an identical angle in a different direction.

In some embodiments where discrete potential orientations are provided, the plurality of discrete orientations is four discrete orientations.

In some embodiments, the first orientation fixation feature comprises a plurality of teeth defined at regular intervals, and the second orientation fixation feature comprises a corresponding plurality of teeth at regular intervals.

In some such embodiments, the first orientation fixation feature is at an inner surface of the first bore and the second orientation fixation feature is at an outer surface of the adapter ring.

In some embodiments, the adapter ring has an outer surface with rotational symmetry, and an outer surface axis of symmetry of the adapter ring is not colinear or parallel with the second axis of symmetry.

In some such embodiments, the outer surface axis of symmetry and the second axis of symmetry coincide at a meeting location spaced apart from the adapter ring.

In some such embodiments, the first bore is blind and the meeting location is adjacent an end of the first bore. In some such embodiments, the end of the first bore has an aperture for admitting a screw.

In some embodiments, when assembled, an end of the golf club shaft extends through the second bore and into the first bore, and the golf club shaft has an axial direction defined by the second axis of symmetry and at least partially reinforced by contact with the first bore.

In some embodiments, the fixation assembly further includes a shaft tip adapter extending through the second bore and into the first bore and having an axial direction defined by the second axis of symmetry and at least partially reinforced by contact with the first bore, and wherein the shaft tip adapter has an internal sleeve for receiving the golf club shaft.

In some such embodiments, the adapter ring has a third orientation fixation feature and the shaft tip adapter has a fourth orientation fixation feature for mating with the third orientation fixation feature to fix an orientation of the shaft tip adapter relative to the adapter ring.

In some such embodiments, the golf club shaft has a handle with a defined orientation, and the defined orientation is fixed relative to the golf club head by the mating of the first orientation fixation feature and the second orientation fixture and the mating of the third orientation fixation feature and the fourth orientation fixation feature.

In some such embodiments, the first orientation fixation feature and the second orientation fixation feature mate in one of a defined number of discrete potential orientations, and the third orientation fixation feature and the fourth orientation fixation feature mate in one of the defined number of discrete potential orientations.

In some embodiments utilizing a shaft tip adapter, the shaft tip adapter has a threaded end for receiving a screw, and the screw fixes the shaft tip adapter relative to an end of the first bore.

In some embodiments utilizing a shaft tip adapter, the shaft tip adapter has at least one groove in the axial direction at a distal end, and the first bore has at least one rib at a distal end for mating with the at least one groove.

In some embodiments, the first bore is integrated into a hosel adapter, and wherein the hosel adapter is fixed within the base of the golf club head.

In some embodiments, the first bore is integrated into a hosel adapter, and the hosel adapter is fixed to a neck extending from the golf club head.

In some embodiments, the golf club head is either center shafted or neck style, and the first bore is integrated into the golf club head at a hosel.

In some embodiments, at least portions of the first bore and the adapter ring are tapered, such that once assembled, a tightening of the assembly results in compressive forces.

Also provided is a system for fixing a golf club shaft to a golf club head. Such a system includes a first bore integrated into the golf club head, where the first bore has a first orientation fixation feature and a first axis of symmetry, and a plurality of adapter rings each having a corresponding second bore and a corresponding second orientation fixation feature for mating with the first orientation fixation feature to fix an orientation of the corresponding adapter ring relative to the first bore.

The second bore of each of the plurality of adapter rings has a corresponding second axis of symmetry, and when the corresponding second orientation fixation feature is mated with the first orientation fixation feature, the first axis of symmetry is not colinear or parallel with the corresponding second axis of symmetry.

In some embodiments, each of the plurality of adapter rings has a corresponding outer surface with rotational symmetry, and an outer surface axis of symmetry of the adapter ring is not colinear or parallel with the corresponding second axis of symmetry.

In some such embodiments, for each of the plurality of adapter rings, the outer surface axis of symmetry and the second axis of symmetry define an offset angle relative to each other and coincide at a meeting location spaced apart from the adapter ring by a first distance.

In some such embodiments, for any pair of adapter rings of the plurality of adapter rings, the offset angle is different but the first distance is substantially similar.

In some embodiments, the system includes a shaft tip adapter having an internal sleeve for receiving the golf club shaft. Upon fixing the golf club shaft to the golf club head, the second orientation fixation feature of a first adapter ring of the plurality of adapter rings is mated with the first orientation fixation feature and the shaft tip adapter extends through the corresponding second bore and into the first bore and has an axial direction defined by the second axis of symmetry and at least partially reinforced by contact with the first bore.

In some embodiments of a system, each adapter ring of the plurality of adapter rings has a third orientation fixation feature, and upon fixing the golf club shaft to the golf club head, the second orientation fixation feature of a first adapter ring of the plurality of adapter rings is mated with the first orientation fixation feature, and the third orientation fixation feature of the first adapter ring mates to either a fourth orientation fixation feature on the golf club shaft of a corresponding shaft tip adapter or the second orientation fixation feature of a second adapter ring.

### BRIEF DESCRIPTION OF THE DRAWINGS

FIG. 1 shows an embodiment of the present invention in perspective exploded view: shaft sleeve assembly, hosel adapter interface, with club head and screw-center shafted (CS) style.

FIG. 2 shows the embodiment of FIG. 1 in front exploded view: shaft sleeve assembly, hosel adapter interface, with club head and screw—CS style.

FIG. 3 shows the embodiment of FIG. 1 in front exploded section view: shaft sleeve assembly, hosel adapter interface, with club head and screw—CS style.

FIG. 4 shows the embodiment of FIG. 1 as assembled, including a full golf club—CS style

FIG. 5 shows the embodiment of FIG. 1 in partial exploded perspective detail view: shaft tip sleeve assembly—CS style.

FIG. 6 shows the embodiment of FIG. 1 as assembled in a section detail view: shaft tip sleeve assembly, hosel adapter, club head, and screw—CS style.

FIG. 7 shows a second embodiment of the present invention as assembled in a section detail view: shaft tip sleeve assembly, integral hosel adapter club head, and screw—CS style.

FIG. 8 shows a third embodiment of the present invention as assembled in perspective view: full club—neck style head style.

FIG. 9 shows the embodiment of FIG. 8 in perspective exploded view: full club—neck style head style.

FIG. 10 shows the embodiment of FIG. 8 in a section detail view.

FIG. 11 shows the embodiment of FIG. 8 in a perspective exploded view: shaft sleeve assembly, hosel adapter interface, neck, head, and screws—neck style head style.

FIG. 12 shows a fourth embodiment of the present invention, integrated hosel adapter neck style, in section detail view.

FIG. 13 shows the embodiment of FIG. 12 in perspective exploded view: shaft sleeve assembly, integrated hosel adapter neck, head, and screws—neck style head style.

FIG. 14 shows a detail front section view of a neck tip to head interface in the embodiment of FIG. 12—neck style head style.

FIGS. 15A-D show perspective views of an adapter ring for use in embodiments of the present invention presented in four orientations.

FIGS. 15E-H show a simplified and exaggerated variation of the adapter rings of 15A-D in corresponding orientations.

FIGS. 16A, C, E, and G show top views of the adapter ring of FIG. 15A in four orientations.

FIGS. 16B, D, F, and H show top views of the simplified and exaggerated variation of the adapter ring of FIG. 15E in four corresponding orientations.

FIGS. 16I and J show front section views of the adapter ring of FIG. 16G and the simplified and exaggerated variation of FIG. 16H respectively.

FIGS. 17A and B show an embodiment of the present invention, each in a front view: full club shown in upright and flat lie configurations.

FIGS. 18A-C show an embodiment of the present invention, in a heel side view: full club shown in plus loft, neutral, and minus loft configurations respectively.

FIGS. 19A and B show an embodiment of a shaft tip adapter for use in embodiments of the present invention in a front view and a section view: sleeve tip component with symmetric, coaxial shaft bore.

FIGS. 20A and B show an embodiment of a shaft tip adapter for use in embodiments of the present invention in a front view and a section view: sleeve tip component with asymmetric, tilted angle shaft bore.

FIGS. 21A and B show an embodiment of a hosel adapter component for use in embodiments of the present invention in a front view and a section view: hosel adapter component with symmetric, coaxial outside diameter's axis of symmetry with respect to the internal feature's axis of symmetry.

FIGS. 22A and B show an embodiment of a hosel adapter component for use in embodiments of the present invention in a front view and a section view: hosel adapter component with asymmetric, tilted outside diameter's axis of symmetry with respect to the internal feature's axis of symmetry.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

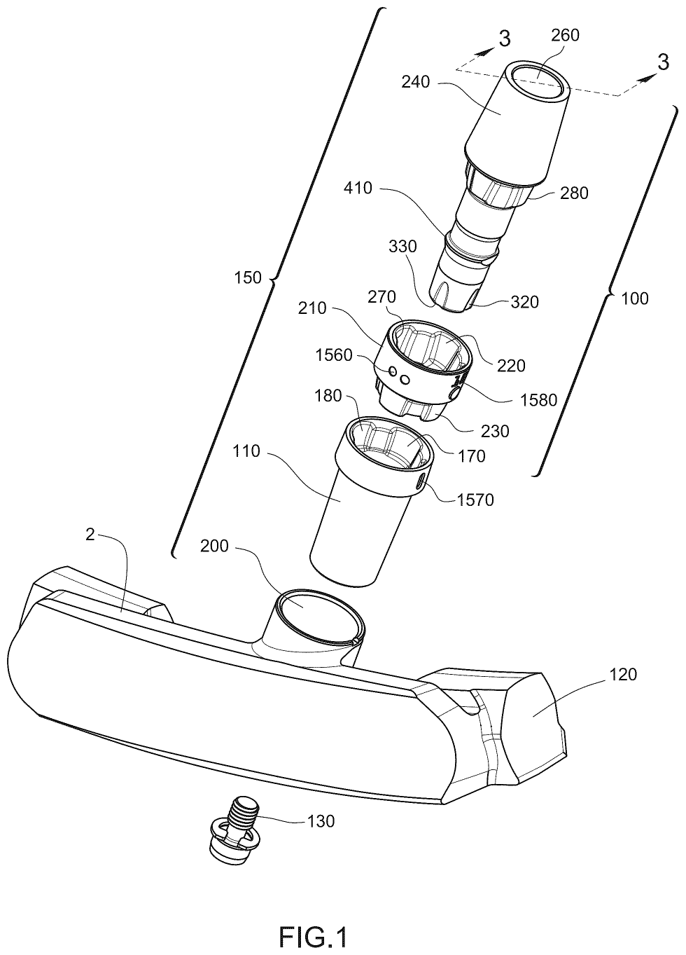

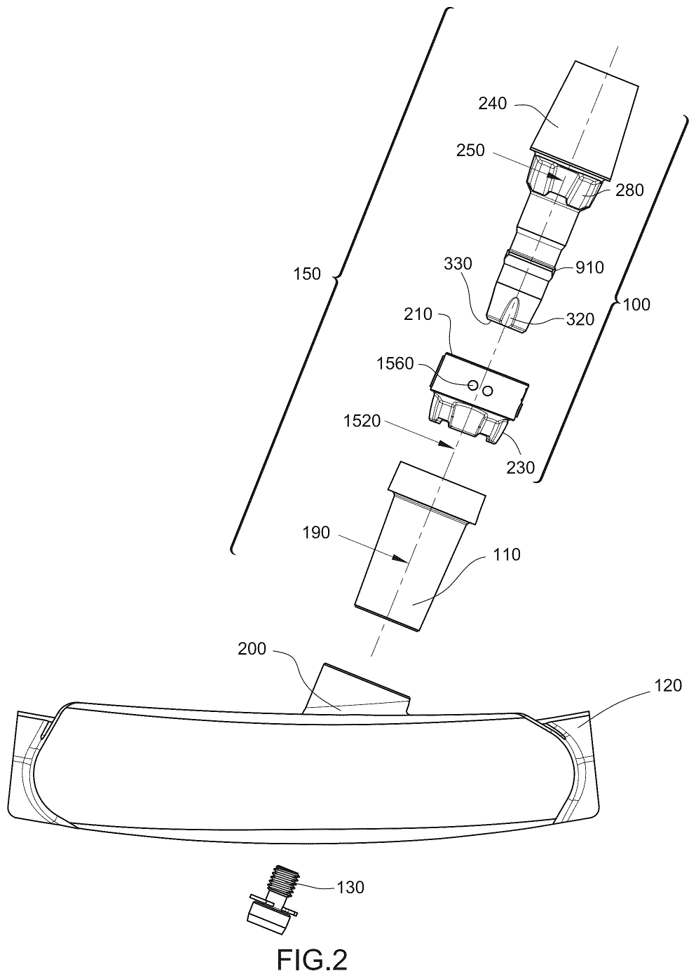

FIG. 1 shows an embodiment of the present invention in perspective exploded view. The figure shows a shaft sleeve assembly 100 and hosel adapter 110 along with a golf club head 120 and screw 130. The golf club head 120 in the embodiment shown is center shafted (CS) style. FIG. 2 shows the embodiment of FIG. 1 in front exploded view, including the shaft sleeve assembly 100, hosel adapter 110, golf club head 120, and screw 130.

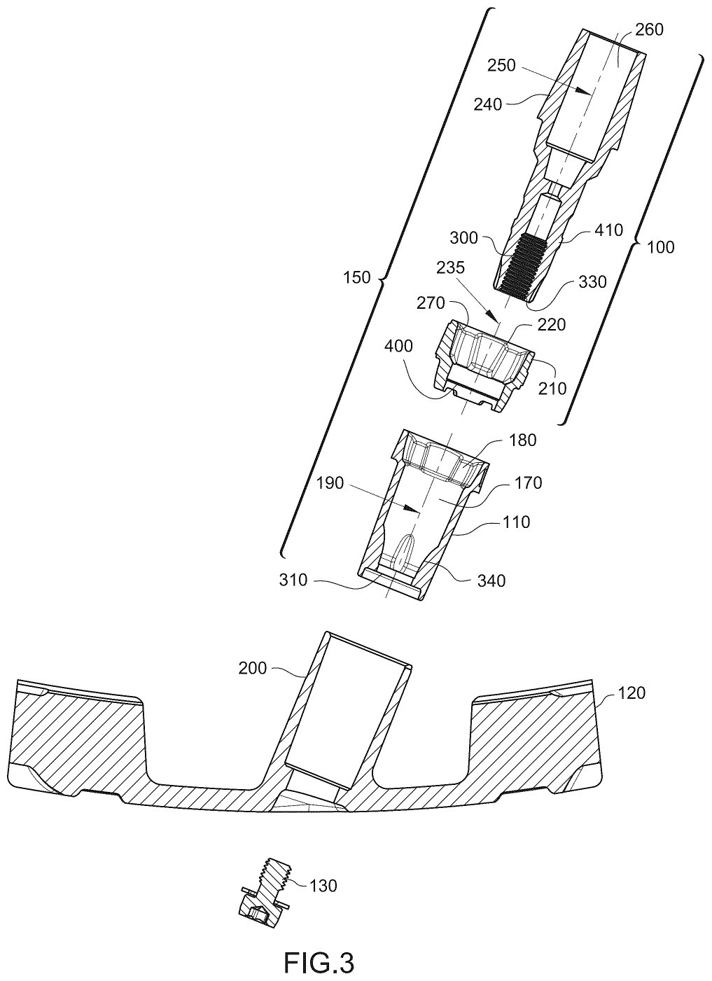

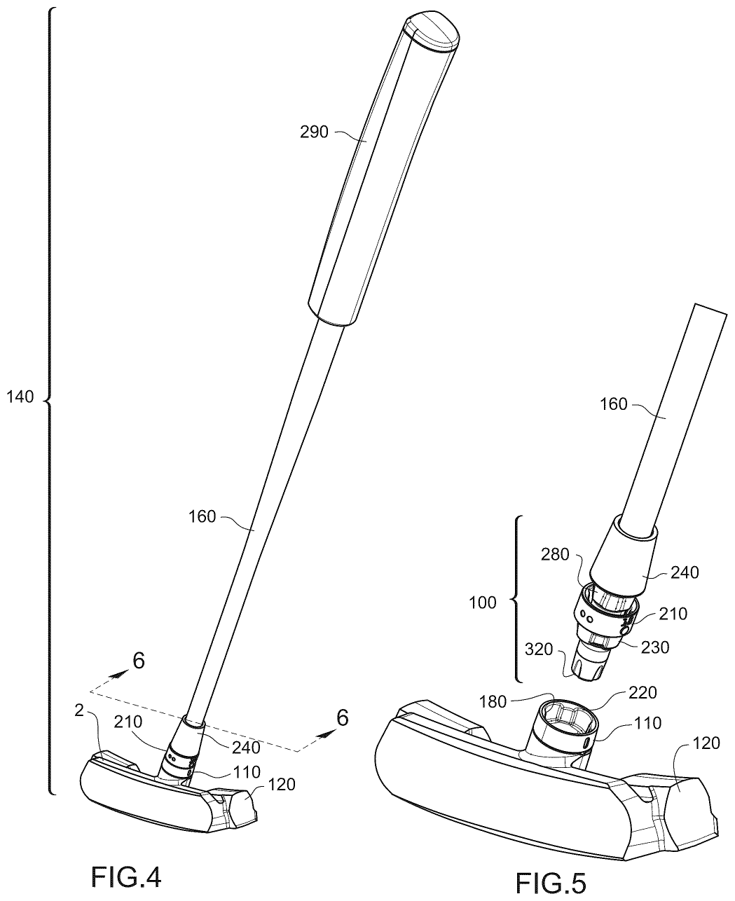

FIG. 3 shows the embodiment of FIG. 1 in front exploded section view, including the shaft sleeve assembly 100, hosel adapter 110, club head 120, and screw 130. FIG. 4 shows the embodiment of FIG. 1 as assembled, including a full golf club 140 including the CS style golf club head 120. FIG. 5 shows the embodiment of FIG. 1 in partial exploded perspective detail view, including the shaft sleeve assembly 100.

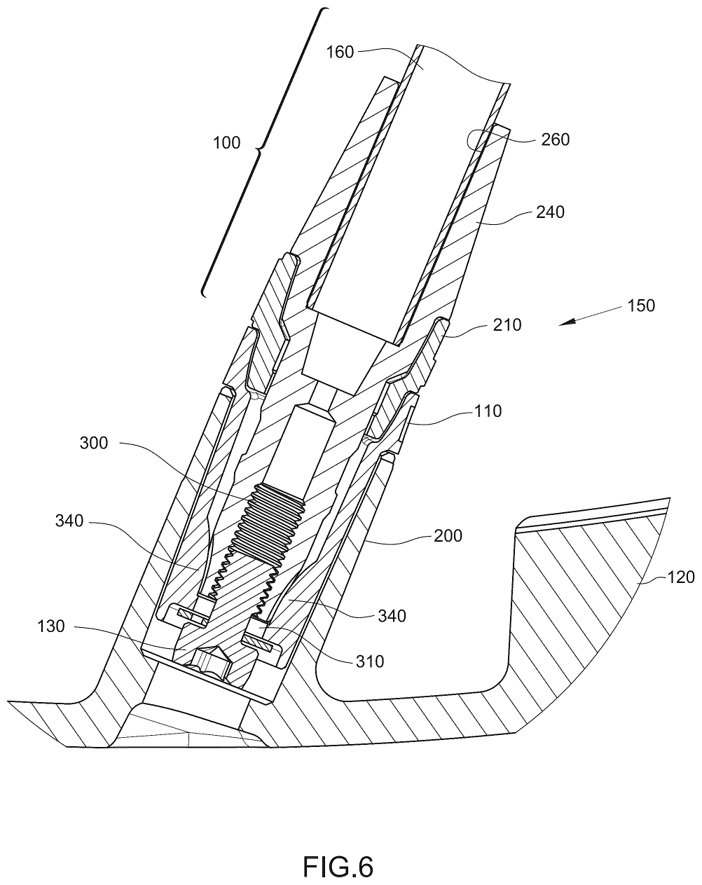

FIG. 6 shows the embodiment of FIG. 1 as assembled in a section detail view, including the shaft sleeve assembly 100, hosel adapter 110, club head 120, and screw 130.

As shown, the components as assembled provide a fixation assembly 150 for fixing a golf club shaft 160 to the golf club head 120. The assembly 150 includes a first bore 170 integrated into the golf club head 120. The first bore 170 includes a first orientation fixation feature 180 and a first axis of symmetry 190. As discussed in more detail below, the embodiment of FIG. 1 provides the first bore 170 within a hosel adapter 110, but in alternative embodiments, the first bore may be provided directly within the golf club head 120 and may thereby be integrated directly into a golf club hosel 200.

The fixation assembly 150 also provides an adapter ring 210. The adapter ring 210 has an inner second bore 220 and a second orientation fixation feature 230. The second orientation fixation feature 230 mates with the first orientation fixation feature 180 in order to fix an orientation of the adapter ring 210 relative to the first bore 170.

The second bore 220, integrated into the adapter ring 210, has a second axis of symmetry 235. When the fixation assembly 150 is assembled, as shown, for example, in FIG. 4, the adapter ring 210 is fixed to the first bore 170, and the second orientation fixation feature 230 is mated with the first orientation fixation feature 180. When the orientation fixation features 180, 230 are so mated, the first axis of symmetry 190 is not colinear or parallel with the second axis of symmetry 235.

The difference between an orientation of the first axis of symmetry 190 and the second axis of symmetry 235 is relatively small and may be referred to as a tilt angle of the second bore 220 relative to the first bore 170. Because small changes in the tilt angle may result in large changes in the resulting behavior of the golf club head 120, the difference between the angles are not necessarily visible in FIGS. 1-6. However, as discussed in more detail below with respect to 15A-F and 16A-J, the angle is more visible in exaggerated illustrations of the components described and may be applied in different orientations in order to generate different resulting behaviors for the golf club 140 taken as a whole.

Accordingly, when assembled, the second axis of symmetry 235 of the inner second bore 220 of the adapter ring 210 defines a different axial direction than the first axis of symmetry 190 of the first bore 170.

The shaft sleeve assembly 100 includes the adapter ring 210 and a shaft tip adapter 240. The shaft tip adapter 240 is generally an elongated element with some degree of rotational symmetry that may be fitted to the end of a golf club shaft 160. As such, the shaft tip adapter 240 may have an internal sleeve 260 for receiving the golf club shaft 160.

The shaft tip adapter 240 is configured to mate with the adapter ring 210 in a controlled way. When assembled, the shaft tip adapter 240 extends through the second bore 220 in the adapter ring 210 and into the first bore 170. The shaft tip adapter 240 has an axial direction 250 which is defined by the second axis of symmetry 235, and that direction is at least partially reinforced by contact with the first bore 170.

As noted above, the shaft tip adapter 240 may have a degree of rotational symmetry. As such, the adapter ring 210 may be provided with a third orientation fixation feature 270. Such a third orientation fixation feature 270 may be, for example, on an inner surface of the second bore 220. The shaft tip adapter 240 may then be provided with a fourth orientation fixation feature 280. The fourth orientation fixation feature 280 may then mate with the third orientation fixation feature 270 to fix an orientation of the shaft tip adapter 240 relative to the adapter ring 210.

Accordingly, by controlling the mating of the first orientation fixation 180 feature with the second orientation fixation feature 235 and controlling the mating of the third orientation fixation feature 270 with the fourth orientation fixation feature 280, a user can define an orientation of a golf club shaft 260 received by the shaft tip adapter 240 relative to the golf club head 120.

In some embodiments, such as that shown, the golf club shaft 160 has a handle 290 with a defined orientation. Accordingly, by controlling the relationships between the mated orientation fixation features 180, 230, 270, 280, the defined orientation of the handle 290 can be fixed relative to the golf club head 160.

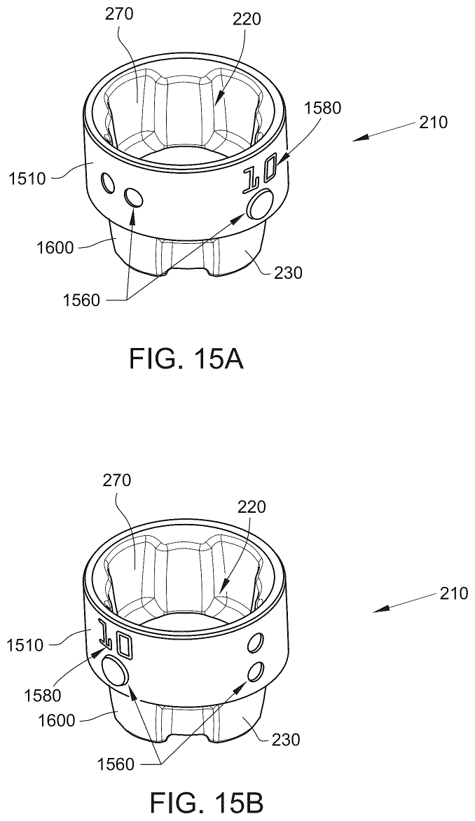

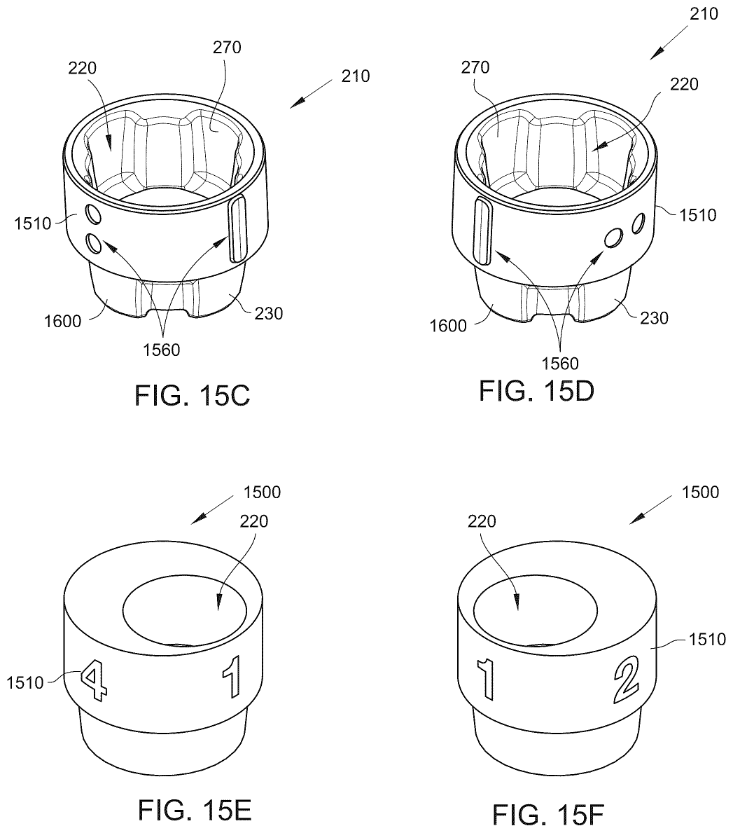

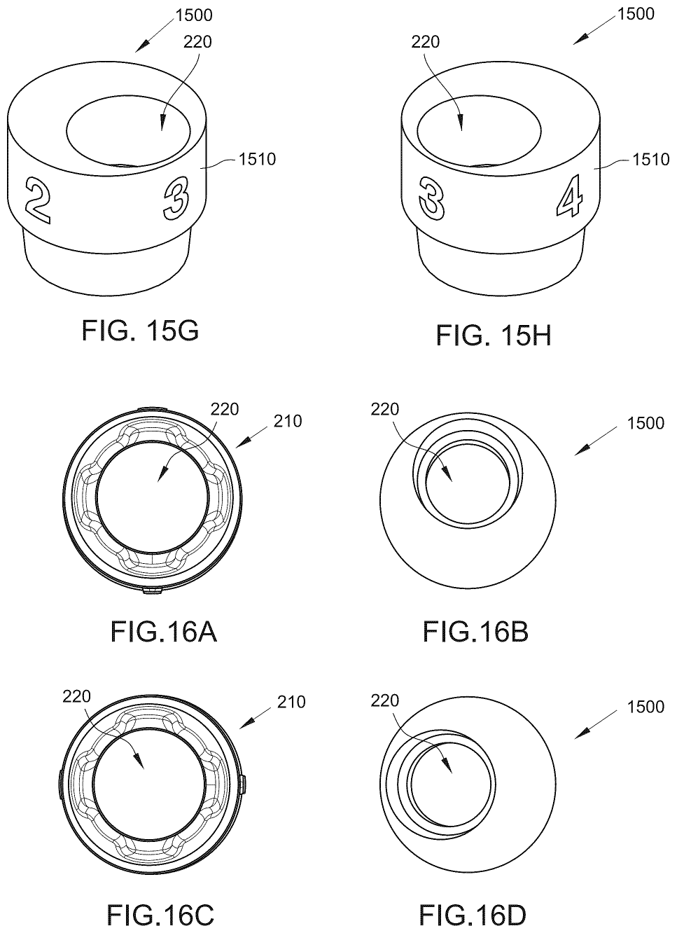

As noted above, the first orientation fixation feature 180 mates with the second orientation fixation feature 230 in order to define the relative orientation of the components. Typically, the first orientation fixation feature 180 and the second orientation fixation feature 230 made in one of a plurality of discrete potential orientations. In the embodiment shown, the orientation fixation features 180, 230 mate in one of four discrete potential orientations. Each of the discrete orientations defines a different relationship between the first axis of symmetry 190 and the second axis of symmetry 235. This is discussed in more detail below with respect to FIGS. 15A-H and 16A-J.

In some embodiments, each of the discrete orientations result in the first axis of symmetry 190 and the second axis of symmetry 235 defining an identical angle relative to each other, but in a different direction.

In embodiments in which the adapter ring 210 has a third orientation fixation feature 270 and the shaft tip adapter 240 has a fourth orientation fixation feature 280, the third orientation fixation feature 270 and the fourth orientation fixation feature 280 may themselves mate in one of defined number of discrete potential orientations. In some such embodiments, the defined number of discrete potential orientations in which the third and fourth orientation fixation features 270, 280 mate may be the same number of discrete potential orientations in which the first and second orientation fixation features 180, 230 mate.

In this way, by providing the same number of orientation configurations between the first bore 170, the golf club shaft 160 may be kept in the same orientation relative to the golf club head 120 regardless of the orientation selected for the adapter ring 210. For example, where the first and second orientation fixation features 180, 230 mate in four discrete orientations, the third and fourth orientation fixation features may similarly mate in four discrete orientations. Accordingly, where the handle 290 has a defined orientation, the handle can be kept properly oriented regardless of the selected configuration.

In some embodiments, instead of providing a discrete shaft tip adapter 240, a golf club shaft 160 is provided with an integrated tip designed for use in the fixation assembly described herein. As such, the tip of the golf club shaft 160 may be provided with the fourth orientation fixation feature 280 otherwise applied to the shaft tip adapter 240. In such embodiments, when assembled, the end of the golf club shaft 160 extends through the second bore 230 into the first bore 170, and the axial direction of the shaft is then defined by the second axis of symmetry 235 and is reinforced by contact with the first bore 170.

When a shaft tip adapter 240 is utilized, the shaft tip adapter may be provided with a threaded end 300 for receiving a screw 130, and the screw may then fix the shaft tip adapter 240 relative to an end 310 of the first bore 170. Similarly, where the shaft itself 160 has a tip designed to be used instead of the shaft tip adapter 240, it may be similarly threaded. Similarly, any features discussed with respect to the shaft tip adapter 240 may similarly be applied to an end of a shaft 160, where the shaft is designed for usage in the fixation assembly 150 described.

In some embodiments, the shaft tip adapter 240 may be provided with at least one groove 320 in the axial direction 250 at a distal end 330 of the shaft tip adapter. The first bore 170 may then be provided with at least one rib 340 at its own distal end 310 for mating with the at least one groove 320. In some embodiments, such as that shown, the grooves 320 and the corresponding ribs 340 may be provided in the same number as the potential mating configurations of the various orientation fixation features 180, 230, 270, 280.

In the embodiment shown, and as discussed above, the first bore 170 is integrated into a hosel adapter 110. The hosel adapter 110 is then fixed within the base of the golf club head 120. This may be by placing the hosel adapter 110 into an existing hosel 200 of the golf club head. Such a fixation may be by use of a press fit, a snap fit, adhesive bond, or any other configuration. In some embodiments, the fixation is reinforced by compression between the screw 130 and the shaft tip adapter 240.

Similarly, other components, such as the adapter ring 210 may be configured to be fixed to adjacent components, such as the first bore 170, by way of a press fit, a snap fit, or other configuration. Accordingly, the connection between the adapter ring 210 and the first bore 170 may be semi-permanent. When the screw 130 is tightened to the shaft tip adapter 240, such a connection may be tightened or reinforced as well.

As shown throughout the drawings, various components of the assembly 150 may be provided with tapers. For example, the first bore 170 and the adapter ring 210 may be tapered. In this way, a tightening of the assembly 150 results in compressive forces that reduce any play in the connection. In this way, firm connections can be reinforced without requiring unreasonable manufacturing tolerances.

Similarly, the end of the shaft tip adapter 240, or the grooves 320 contained therein, may be tapered, along with the corresponding ribs 340. Similarly, the various orientation fixation features 180, 230, 270, 280 may be provided with tapers. In this way, when the screw 130 is tightened, all internal components are aligned. This approach allows for arcuate profiles primarily tapered in the longitudinal direction on the mating radial inboard and outboard faces. This can cause a squeezing and system stiffening effect when compressive force is applied by the screw 130.

The remaining embodiments discussed herein show variations of the fixation assembly 150 described herein. Similar components are indicated using the same reference numerals, and the discussion that follows focuses on distinctions between the secondary embodiments and the embodiment discussed in reference to FIGS. 1-6.

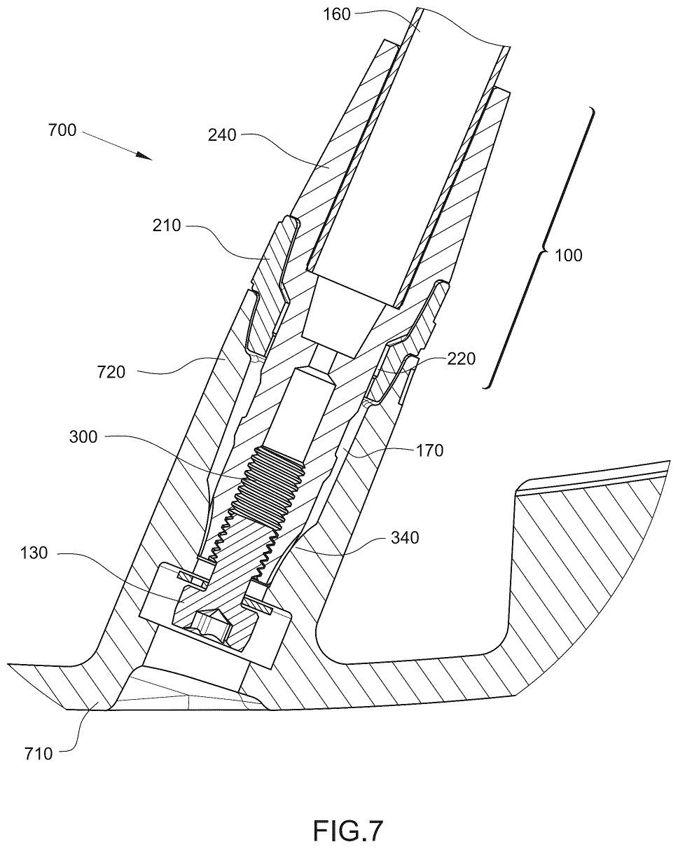

FIG. 7 shows a second embodiment 700 of the present invention as assembled in a section detail view. The embodiment includes a shaft tip sleeve assembly 100, an integral hosel adapter club head 710, and screw 130. As in the embodiment of FIGS. 1-6, the assembly is a center shaft, or CS, style.

As shown, the assembly of embodiment 700 is similar to the fixation assembly 150 of FIG. 1, but does not include a discrete hosel adapter 110. Instead, the bore 170 is integrated directly into the hosel 720 of the golf club head 710 provided.

In this embodiment, the shaft sleeve assembly 100 is identical to that described above, and therefore includes an adapter ring 210 and a shaft tip adapter 240. As discussed above, the shaft tip adapter 240 is configured to mate with the adapter ring 210 in a controlled way. When assembled, the shaft tip adapter 240 extends through the second bore 220 in the adapter ring 210 and into the first bore 170, in this case integrated directly into the hosel 720. When considered in the context of embodiment 1, the axial direction 250 of the shaft tip adapter 240 is then defined by the second axis of symmetry 235, and that direction is at least partially reinforced by contact with the first bore 170.

As in the case of the hosel adapter 110 discussed above, the first bore 170 integrated directly into a hosel 720 is similarly provided with a first orientation fixation feature 180 and may therefore function similarly to the hosel adapter 110 of the first embodiment 150. Accordingly, for example, the first bore 170 of the hosel 720 may be provided with ribs 340 in the same way that the hosel adapter 110 of the first embodiment 150 incorporates the same.

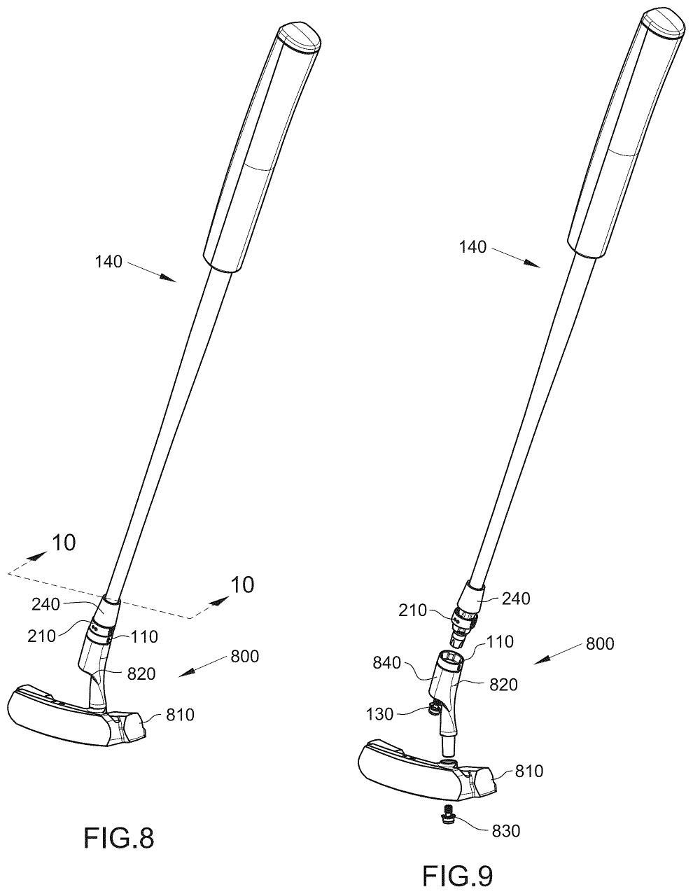

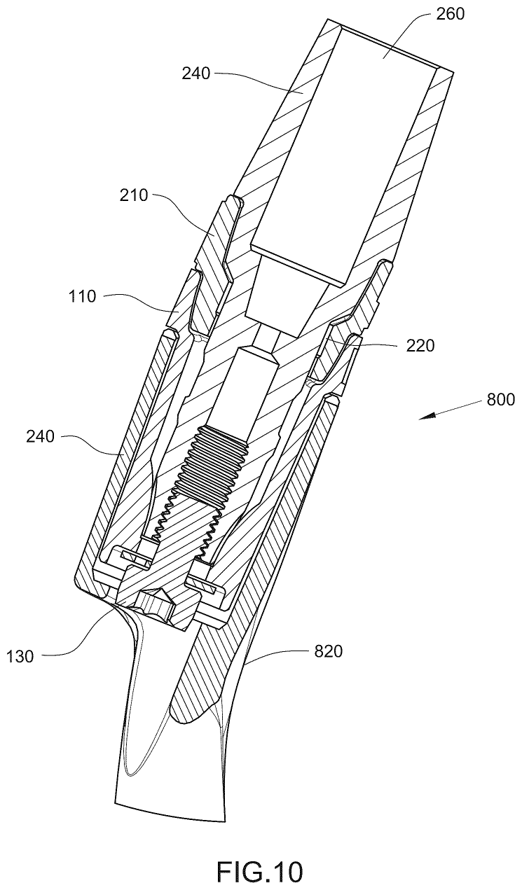

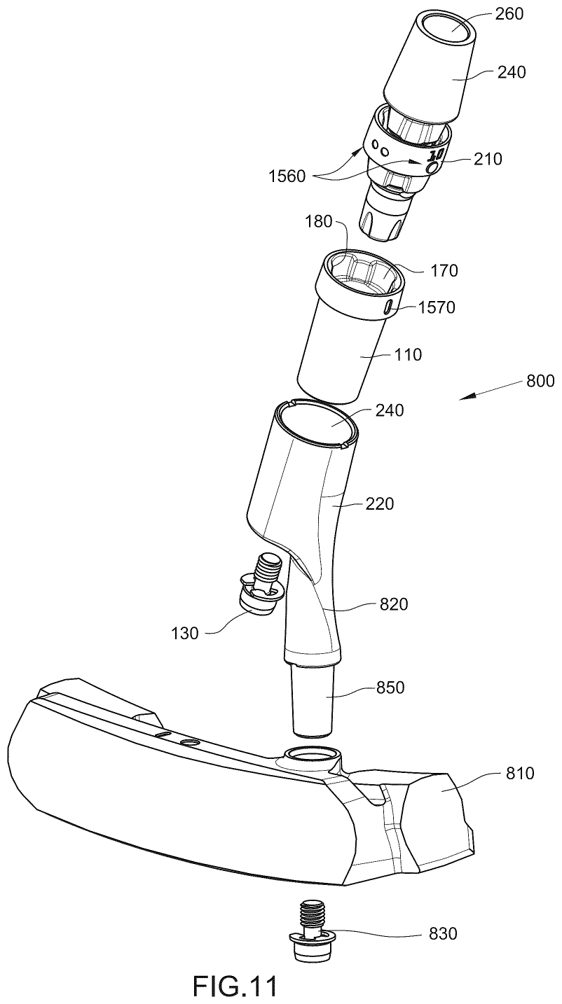

FIG. 8 shows a third embodiment 800 of the present invention as assembled in perspective view: the drawing shows a full club 140 with a neck style head style 810. FIG. 9 shows the embodiment 800 of FIG. 8 in perspective exploded view. FIG. 10 shows the embodiment 800 of FIG. 8 in a section detail view. FIG. 11 shows the embodiment 800 of FIG. 8 in a perspective exploded view, including a shaft sleeve assembly 100, a hosel adapter 110, a neck 820, head 810, and screws 130, 830.

The configuration shown in the third embodiment 800 is similar to that discussed above with respect to the first embodiment of the fixation assembly 150 shown in FIG. 1. Accordingly, as shown, a first bore 170 is integrated into a hosel adapter 110. The first bore 170 includes a first orientation fixation feature 180, and in fact, the hosel adapter 110 may be similar or identical to that discussed above.

Accordingly, an adapter ring 210 is provided having an inner second bore 220 similar to that described above, and a shaft tip adapter 240 is provided for retaining a shaft 160 in a corresponding internal sleeve 260, and the shaft tip adapter 240 in combination with the second bore 220 then define the orientation of the shaft 160.

The embodiment 800 of FIG. 8 differs from those discussed above, in that the golf club head 810 is a neck style head. Accordingly, a neck 820 is provided including a hosel 840, and the hosel adapter 110 is then located within the hosel during use. Accordingly, while in the embodiment 150 of FIG. 1, the first bore 170 is integrated into a hosel adapter 110 which is in turn fixed within the base of a golf club head 120, the embodiment 800 shown in FIG. 8 instead provides the first bore 170 integrated into a hosel adapter 110 which is in turn fixed to a neck 820 which extends from the golf club head 810.

In some embodiments, such as that shown, multiple connection interfaces may be used. Accordingly, the shaft sleeve assembly 100 may be fixed to the hosel 840 and hosel adapter 110 by a first screw 130, as in the embodiments discussed above. The hosel 840 and neck 820 may then be connected to the golf club head 810 by a second interface 850 utilizing a second screw 830.

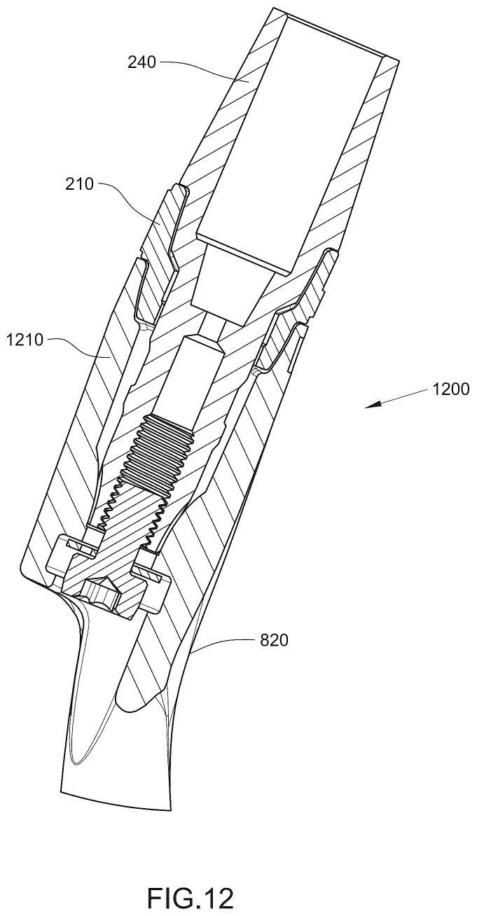

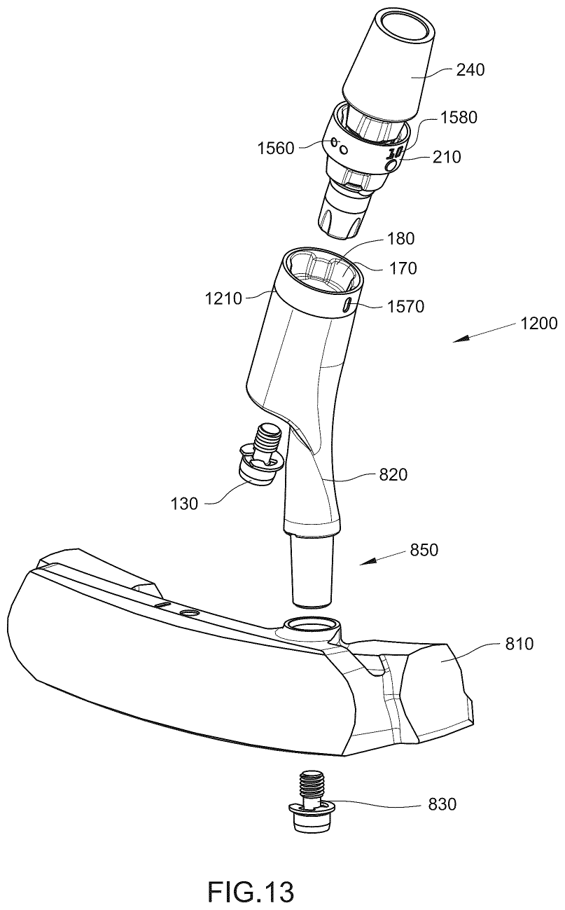

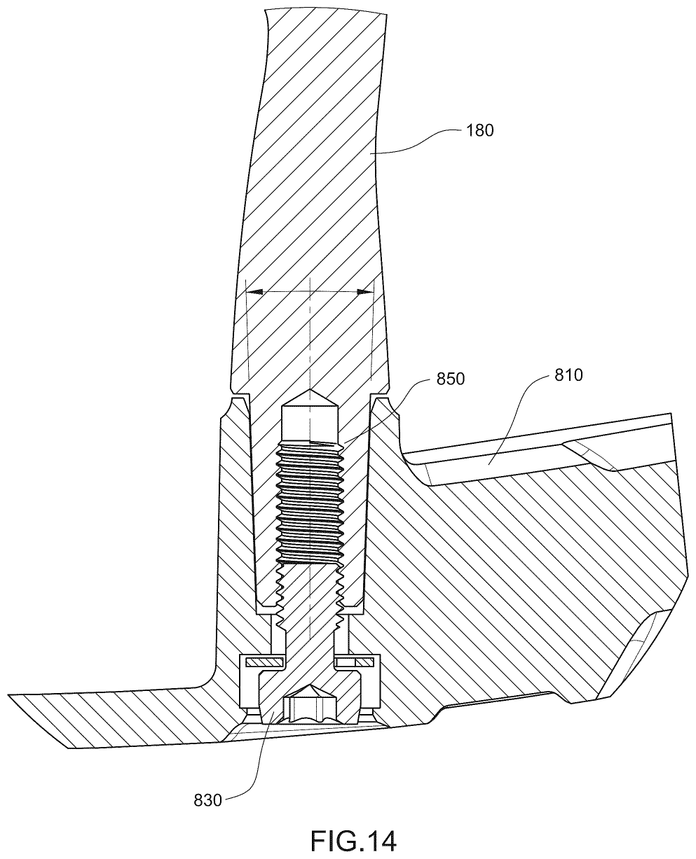

FIG. 12 shows a fourth embodiment 1200 of the present invention in section detail view. FIG. 13 shows the embodiment 1200 of FIG. 12 in perspective exploded view, including the shaft sleeve assembly 100, an integrated hosel adapter neck 1210, head 810, and screws 130, 830, in a neck style head style. FIG. 14 shows a detail front section view of a neck tip to head interface 850 in the embodiments of FIGS. 8 and 12 in a neck style head style 810. The configuration shown in the fourth embodiment 1200 is similar to the neck style embodiment 800 of FIG. 8, but incorporates a first bore 170 with a first orientation fixation feature 180 incorporated directly into a hosel 1210 located within the neck 820. The first bore 170 may include features similar to the hosel adapter 110 described throughout as well as the first bore described in the hosel 720 of FIG. 7.

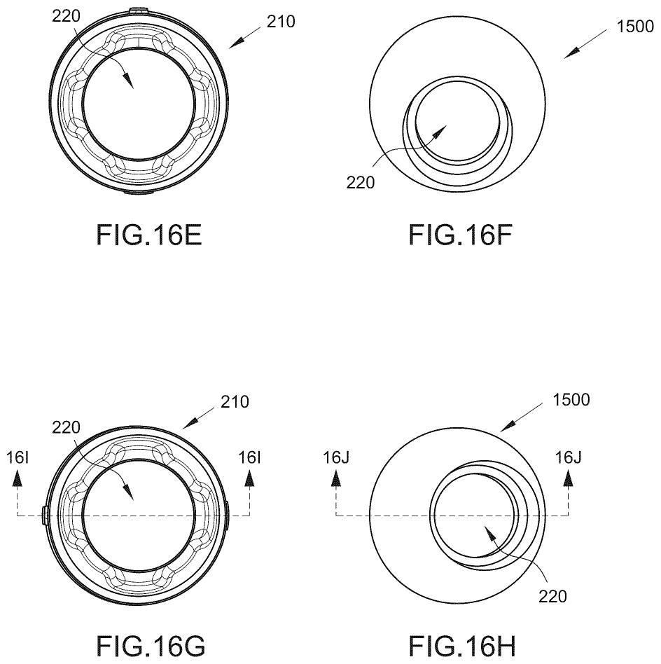

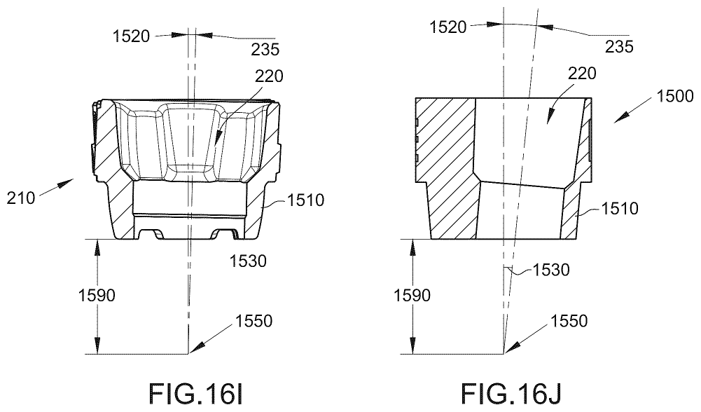

FIGS. 15A-D show perspective views of an adapter ring 210 for use in embodiments of the present invention presented in four orientations. FIGS. 15E-H show a simplified and exaggerated variation 1500 of the adapter rings 210 of 15A-D in corresponding orientations. FIGS. 16A, C, E, and G show top views of the adapter ring 210 of FIG. 15A in four orientations. FIGS. 16B, D, F, and H show top views of the simplified and exaggerated variation 1500 of the adapter ring of FIG. 15E in four corresponding orientations. FIGS. 16I and J show front section views of the adapter ring 210 of FIG. 16G and the simplified and exaggerated variation 1500 of FIG. 16H respectively.

It is noted that because the exaggerated variation 1500 is provided to illustrate the geometry described herein, the variation typically includes identical components to the adapter ring 210 provided in exaggerated relationships to each other. As such, in describing the same, the exaggerated variation 1500 will be provided with the same reference numerals as the adapter ring 210 itself.

As shown, and as discussed above in the context of the embodiment 150 of FIG. 1, the adapter ring 210 has an inner second bore 220 and a second orientation fixation feature 230 for mating with a first orientation fixation feature 180 of a first bore 170. The first bore 170 may be integrated directly into a hosel 720 or into a hosel adapter 110 which itself is located in a hosel 200 during use.

The second bore 220 has an axis of symmetry 235, and when mated with the hosel 720 or hosel adapter 110 during use, the axis of symmetry of the second bore is not colinear or parallel with an axis of symmetry 190 of the first bore 170.

As shown, the adapter ring 210 has an outer surface 1510 with its own rotational symmetry, thereby providing an outer surface axis of symmetry 1520. The outer surface axis of symmetry 1520 is similarly not colinear or parallel with the axis of symmetry 235 of the second bore 220. These distinct axes 235, 1520 are illustrated, for example, in FIGS. 16I and J respectively. During use, the outer surface axis of symmetry 1520 would typically coincide with the axis of symmetry 190 of the first bore 170.

In embodiments where the axis of symmetry 190 of the first bore 170 coincides with the outer surface axis of symmetry 1520 of the adapter ring 210, a tilt angle 1530 between the axis of symmetry 235 of the second bore 220 and the outer surface axis of symmetry 1520 thereby defines a tilt angle of the assembly. When the adapter ring 210 is mated to the hosel 720 or hosel adapter 110 during use, the tilt angle of the assembly is defined by the tilt angle 1530. As discussed above, the adapter ring 210 can mate to the hosel 720 or hosel adapter 110 in several discrete orientations. In each of those discrete orientations, the first axis of symmetry 190 of the first bore 170 and the second axis of symmetry 235 of the second bore 220 define the same tilt angle 1530, but in different direction.

In addition to the two axes of symmetry 235, 1520 of the adapter ring 210 being angled relative to each other by a tilt angle 1530, the axis of symmetry 235 of the second bore 220 is typically offset relative to the outer surface axis of symmetry 1520. Accordingly, the outer surface axis of symmetry 1520 and the second axis of symmetry 235 coincide at a meeting location 1550 spaced apart from the adapter ring 210.

When assembled, as shown, for example, in FIG. 6, the meeting location 1550 may be within the first bore 170. Typically, the first bore 170 may be a blind bore with an end 310, and the meeting location 1550 may be configured to be at or adjacent the end of the first bore. When assembled, the shaft tip adapter 240 extends through the second bore 220 and ends at the meeting location 1550. The first bore 170 may then have an aperture for admitting the screw 130, which engages the end 330 of the shaft tip adapter 240. In some embodiments, a discrete spherical angle adjustment procession pivots nearer the distal screw end of the shaft tip adapter 240, in order to minimize screw head movement and as a result minimize access hole size for the screw drive.

As shown, the adapter ring 210 may be provided with arbitrary unique marks 1560 in order to identify specific configurations. These arbitrary unique marks 1560, represented by numbers in the simplified and exaggerated variation 1500, may be used to identify a particular configuration. As such, a corresponding reference mark 1570 may be provided on the hosel 720 or hosel adapter 110, and the assembly 150 may be placed in a desired configuration by aligning a specified arbitrary unique mark 1560 with the reference mark 1570.

Also provided on the adapter ring 210 is a tilt angle indicator 1580. Such an indicator 1580 may identify a precise tilt angle implemented by the particular adapter ring 210.

In some embodiments, a system is provided for fixing a golf club shaft 160 to a golf club head 120. In such an embodiment, the assembly 150 described above may be provided, but instead of a single adapter ring 210, a plurality of adapter rings may be provided, each having a corresponding second bore 235. In such an embodiment, each adapter ring may define an offset angle, or tilt angle 1530, as discussed above. However, each adapter ring 210 may define a different offset angle, or tilt angle, relative to the others.

As discussed above, the offset of the outer surface axis of symmetry 1510 and the axis of symmetry 235 of the second bore 220 define an angle, namely the tilt angle 1530, and also define a meeting location 1550 outside of the adapter ring 210 at which the axes meet. In systems comprising multiple adapter rings 210, each such adapter ring may have a meeting location 1550 spaced apart from the adapter ring 210 by a single defined first distance 1590. In this way, each adapter ring 210 can mate with the same hosel 720 or hosel adapter 110 and locate the end 330 of the shaft tip adapter 240 at the same meeting location 1550.

As such, a user may use the plurality of adapter rings 210 to select a desired offset, or tilt angle 1530 for a group of available angles, and the adapter rings may thereby be used interchangeably. In such an embodiment, the indicator 1580 may be provided on each adapter ring 210 to indicate the precise tilt angle 1530 of that particular adapter ring.

The first and second orientation fixation features 180, 220 are typically provided as interlocking cog elements. In some embodiments, in order to conceal the orientation fixation features 180, 220 when assembled, the features may be provided on inner radial surfaces of the corresponding components. As shown in FIG. 1, for example, the first orientation fixation feature 180 may be provided on an inner surface of the hosel adapter 110. Accordingly, as shown, the second orientation fixation feature 220 has teeth 1600 defined at regular intervals, and the first orientation fixation feature 180 similarly comprises a corresponding set of teeth also defined at regular intervals.

Similarly, as shown, the second orientation fixation feature 220, may be located on the outer surface 1510 of the adapter ring 210. The orientation fixation features 180, 220 may each comprise a plurality of teeth 1600 defined at regular intervals. These teeth 1600 may be interlocking cog elements, such that cog protrusions on both the hosel adapter 110 and the distal end of the adapter ring 210 are nested into their respective mating depressions. In such embodiments, the cogs, or teeth 1600, are akin to a ring gear-like radial meshing rather than face gear-like meshing of teeth. Upon assembly, the interfaces thereby mesh with adjacent elements, and thereby appear as a straight line rather than jagged steps.

In the embodiment shown, the first orientation fixation feature 180 is at an inner surface of the first bore 170. The second orientation fixation feature 220 is then at an outer surface of the adapter ring 210.

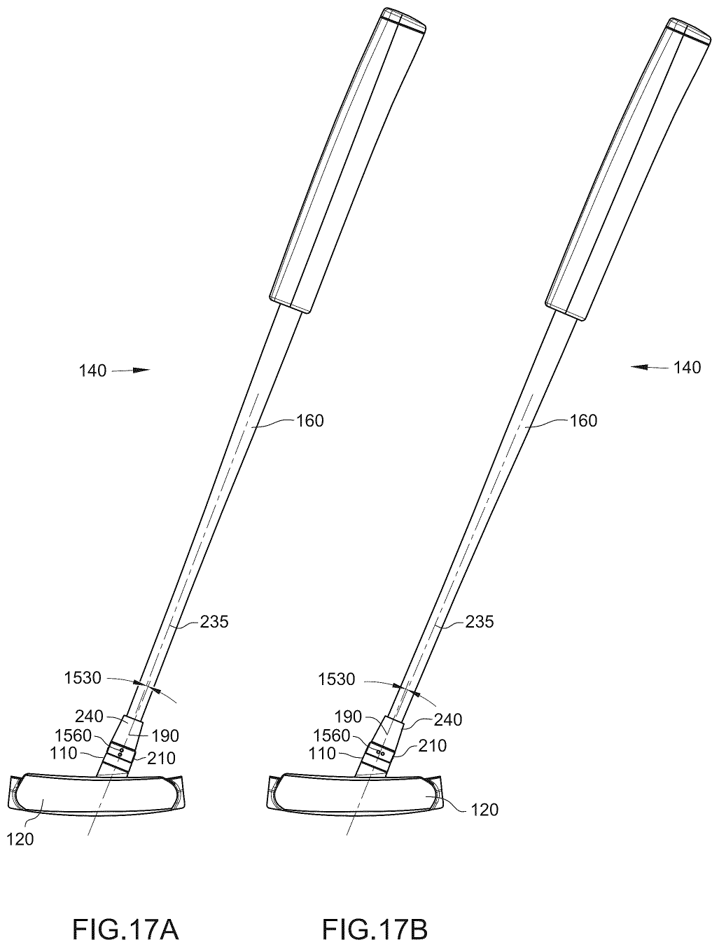

FIGS. 17A and B show an embodiment of the present invention, each in a front view: full club 140 shown in upright and flat lie configurations respectively. As discussed above, the adapter ring 210 can mate to the hosel 720 or hosel adapter 110 in several discrete orientations. In each of those discrete orientations, the first axis of symmetry 190 of the first bore 170 and the second axis of symmetry 235 of the second bore 220 define the same tilt angle 1530, but in different direction. The different configurations can typically be identified by arbitrary unique marks 1560 visible from a given perspective.

Because the shaft 160 is fixed to the shaft tip adapter 240, the configuration defines an angle of the shaft relative to the golf club head 120. This allows the same golf club 140 to be built in different configurations.

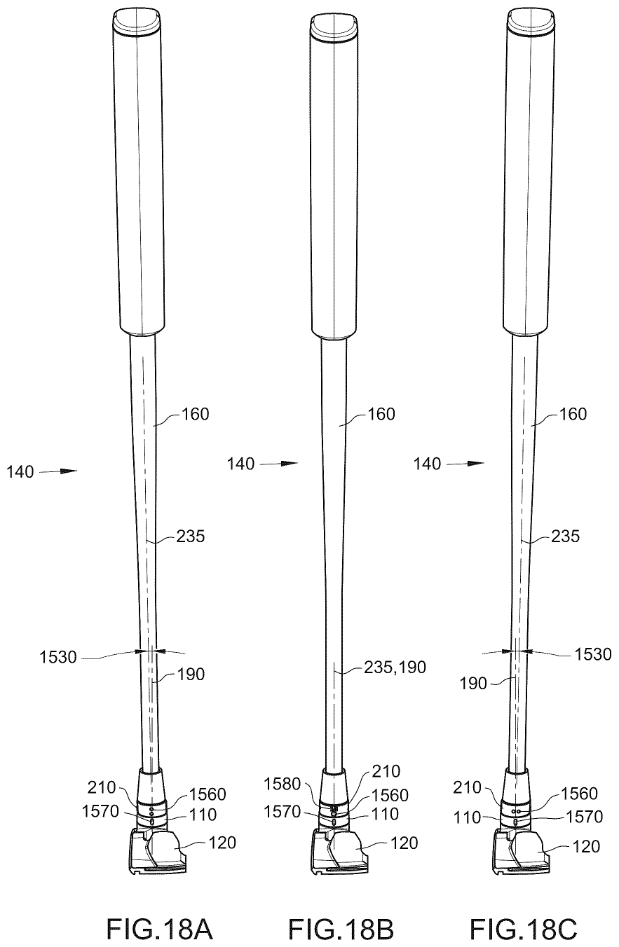

Similarly, FIGS. 18A-C show an embodiment of the present invention, in a heel side view: full club 140 shown in plus loft, neutral, and minus loft configurations respectively.

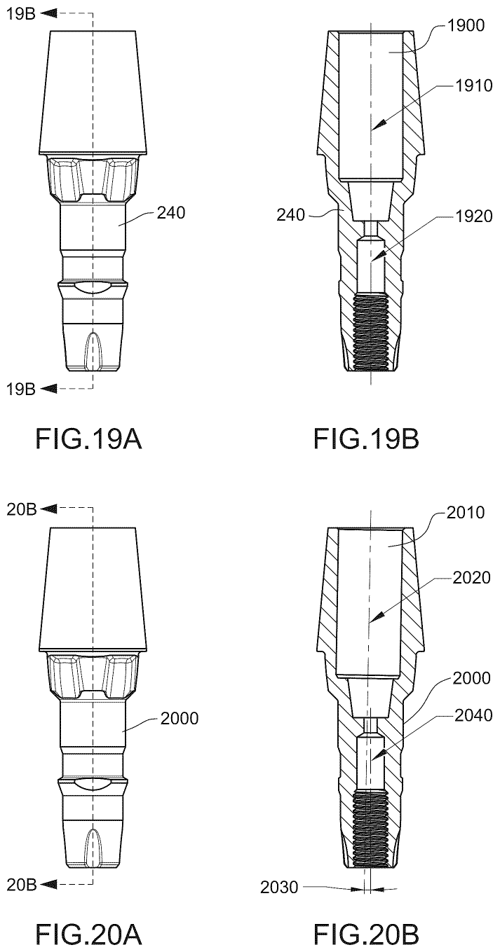

FIGS. 19A and B show an embodiment of a shaft tip adapter 240 for use in embodiments of the present invention in a front view and a section view: sleeve tip component with symmetric, coaxial shaft bore 1900.

As shown, in typical embodiments, the shaft bore 1900 is coaxial with the shaft tip adapter 240 as a whole. As such, an axis 1910 of the shaft bore is aligned with an axis 1920 of the shaft tip adapter 240. In such embodiments, the shaft tip adapter 240 is fixed in place with a given orientation by the adapter ring 210, as discussed above. The shaft bore 1900 then receives the shaft 160 of the golf club 140 and fixes its orientation. The shaft tip adapter 240 then aligns the golf club shaft 160 with the internal bore 220 of the adapter ring 210. The shaft tip adapter 240 is then neutral.

FIGS. 20A and B show an embodiment of a shaft tip adapter 2000 for use in embodiments of the present invention in a front view and a section view: a sleeve tip component with an asymmetric, tilted angle shaft bore 2010.

As shown, the shaft bore may have an axis 2020 that has a tilt angle 2030 relative to an axis 2040 of the shaft tip adapter 2000 as a whole. In this way, the shaft tip adapter 2000 may introduce a tilt angle 2030 that sets a baseline for the tilt introduced by the adapter ring 210, and which may increase or decrease the angle depending on the configuration used.

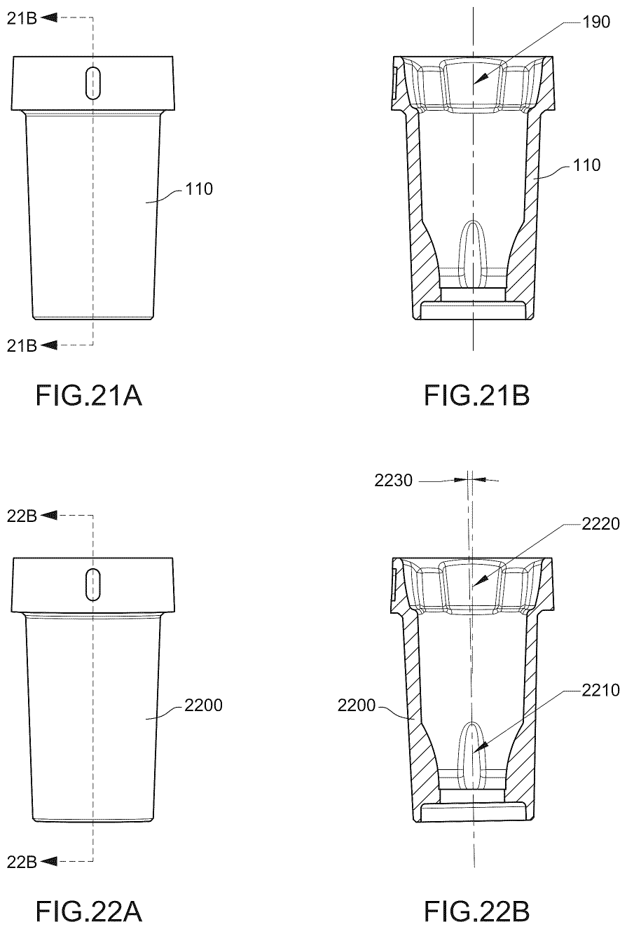

FIGS. 21A and B show an embodiment of a hosel adapter component 110 for use in embodiments of the present invention in a front view and a section view: hosel adapter component with symmetric, coaxial outside diameter's axis of symmetry with respect to the internal feature's axis of symmetry 190, namely the axis of the first bore 170. As discussed above with respect to the shaft tip adapter 240, such a coaxial arrangement results in a single axis of symmetry 190 and the hosel adapter 110 is neutral

FIGS. 22A and B show an embodiment of a hosel adapter component 2200 for use in embodiments of the present invention in a front view and a section view: hosel adapter component with asymmetric, tilted outside diameter's axis of symmetry 2210 with respect to the internal feature's axis of symmetry 2220. Accordingly, the outside diameter axis of symmetry 2210 and the internal feature axis of symmetry 2220 together define a tilt angle 2230.

As discussed above with respect to the asymmetric shaft tip adapter 240, the hosel adapter component 2200, when fixed within a golf club head 120, may increase or decrease the resulting angle of the system, depending on the configuration used.

It is noted that the embodiments illustrated herein are generally in the context of putters. It will be understood that the implementation of this technology can be generally applied to other golf clubs including drivers, woods, irons, and wedges. Therefore, the description presented herein and subsequent claims should be considered broadly to cover all potential styles of golf club.

In some embodiments, the adapter ring 210 is intended to remain captive to the shaft tip adapter 240 in practice, thereby forming the shaft sleeve assembly 100.

This captive function may be accomplished by annular snap assembly of the adapter ring 210 as a full or partial circumferential retaining rim 400 feature of smaller diameter on the ring passes over a full or partial circumferential retaining rim 410 of larger diameter on the sleeve. Alternatively, the adapter ring 210 may be retained by the addition of a third capturing component (not shown)—including but not limited to retaining rings, clips, or pins. In some such embodiments, the adapter ring 210 may then be fixed in place on the shaft tip adapter 240. In other such embodiments, the components 210, 240 can be separated sufficiently to allow the adapter ring 210 to rotate relative to the shaft tip adapter 240, thereby accommodating switching the assembly between configurations.

By providing the subassembly 100 as a semi-permanent snap, a user may replace the adapter ring 210, either for reasons of service replacement or for extending the range of angle adjustment. The snap design may be provided of a tuned size, shape, and material, so as to exploit elastic deflections of the elements and ensure that repeated attachments and removals are possible without permanent and destructive deformations.

In some embodiments, the assembly 100 is intended to be permanently bonded to the distal tip of a typical shaft 160—either during club manufacturer production of a complete club system 140, or by a club fitter in the assembly of compatible shaft components.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A fixation assembly for fixing a golf club shaft to a golf club head comprising:
a first bore integrated into the golf club head, the first bore having a first orientation fixation feature and a first axis of symmetry;
an adapter ring having an inner second bore and a second orientation fixation feature for mating with the first orientation fixation feature to fix an orientation of the adapter ring relative to the first bore;
wherein the second bore has a second axis of symmetry, and wherein when the second orientation fixation feature is mated with the first orientation fixation feature, the first axis of symmetry is not colinear or parallel with the second axis of symmetry.

2. The fixation assembly of claim 1 wherein the first orientation fixation feature and the second orientation fixation feature mate in one of a plurality of discrete potential orientations, and wherein each of the discrete potential orientations defines a different relationship between the first axis of symmetry and the second axis of symmetry.

3. The fixation assembly of claim 2 wherein, in each of the discrete orientations, the first axis of symmetry and the second axis of symmetry define an identical angle in a different direction.

4. The fixation assembly of claim 2, wherein the plurality of discrete orientations is four discrete orientations.

5. The fixation assembly of claim 1 wherein the first orientation fixation feature comprises a plurality of teeth defined at regular intervals, and wherein the second orientation fixation feature comprises a corresponding plurality of teeth at regular intervals.

6. The fixation assembly of claim 5 wherein the first orientation fixation feature is at an inner surface of the first bore and wherein the second orientation fixation feature is at an outer surface of the adapter ring.

7. The fixation assembly of claim 1 wherein the adapter ring has an outer surface with rotational symmetry, and wherein an outer surface axis of symmetry of the adapter ring is not colinear or parallel with the second axis of symmetry.

8. The fixation assembly of claim 7 wherein the outer surface axis of symmetry and the second axis of symmetry coincide at a meeting location spaced apart from the adapter ring.

9. The fixation assembly of claim 8 wherein the first bore is blind and the meeting location is adjacent an end of the first bore.

10. The fixation assembly of claim 9 wherein the end of the first bore has an aperture for admitting a screw.

11. The fixation assembly of claim 1 wherein, when assembled, an end of the golf club shaft extends through the second bore and into the first bore, and wherein the golf club shaft has an axial direction defined by the second axis of symmetry and at least partially reinforced by contact with the first bore.

12. The fixation assembly of claim 1 further comprising a shaft tip adapter extending through the second bore and into the first bore and having an axial direction defined by the second axis of symmetry and at least partially reinforced by contact with the first bore, and wherein the shaft tip adapter has an internal sleeve for receiving the golf club shaft.

13. The fixation assembly of claim 12 wherein the adapter ring has a third orientation fixation feature and wherein the shaft tip adapter has a fourth orientation fixation feature for mating with the third orientation fixation feature to fix an orientation of the shaft tip adapter relative to the adapter ring.

14. The fixation assembly of claim 13, wherein the golf club shaft has a handle with a defined orientation, and wherein the defined orientation is fixed relative to the golf club head by the mating of the first orientation fixation feature and the second orientation fixture and the mating of the third orientation fixation feature and the fourth orientation fixation feature.

15. The fixation assembly of claim 14, wherein the first orientation fixation feature and the second orientation fixation feature mate in one of a defined number of discrete potential orientations, and wherein the third orientation fixation feature and the fourth orientation fixation feature mate in one of the defined number of discrete potential orientations.

16. The fixation assembly of claim 12 wherein the shaft tip adapter has a threaded end for receiving a screw, wherein the screw fixes the shaft tip adapter relative to an end of the first bore.

17. The fixation assembly of claim 12, wherein the shaft tip adapter has at least one groove in the axial direction at a distal end, and wherein the first bore has at least one rib at a distal end for mating with the at least one groove.

18. The fixation assembly of claim 1, wherein the first bore is integrated into a hosel adapter, and wherein the hosel adapter is fixed within the base of the golf club head.

19. The fixation assembly of claim 1, wherein the first bore is integrated into a hosel adapter, and wherein the hosel adapter is fixed to a neck extending from the golf club head.

20. The fixation assembly of claim 1, wherein the golf club head is either center shafted or neck style, and wherein the first bore is integrated into the golf club head at a hosel.

21. The fixation assembly of claim 1 wherein at least portions of the first bore and the adapter ring are tapered, such that once assembled, a tightening of the assembly results in compressive forces.

22. A system for fixing a golf club shaft to a golf club head, the system comprising:
a first bore integrated into the golf club head, the first bore having a first orientation fixation feature and a first axis of symmetry;
a plurality of adapter rings each having a corresponding second bore and a corresponding second orientation fixation feature for mating with the first orientation fixation feature to fix an orientation of the corresponding adapter ring relative to the first bore;
wherein the second bore of each of the plurality of adapter rings has a corresponding second axis of symmetry, and wherein when the corresponding second orientation fixation feature is mated with the first orientation fixation feature, the first axis of symmetry is not colinear or parallel with the corresponding second axis of symmetry.

23. The system of claim 22, wherein each of the plurality of adapter rings has a corresponding outer surface with rotational symmetry, and wherein an outer surface axis of symmetry of the adapter ring is not colinear or parallel with the corresponding second axis of symmetry.

24. The system of claim 23, wherein for each of the plurality of adapter rings, the outer surface axis of symmetry and the second axis of symmetry define an offset angle relative to each other and coincide at a meeting location spaced apart from the adapter ring by a first distance.

25. The system of claim 24, wherein for any pair of adapter rings of the plurality of adapter rings, the offset angle is different but the first distance is substantially similar.

26. The system of claim 22 further comprising a shaft tip adapter having an internal sleeve for receiving the golf club shaft, and wherein upon fixing the golf club shaft to the golf club head, the second orientation fixation feature of a first adapter ring of the plurality of adapter rings is mated with the first orientation fixation feature and the shaft tip adapter extends through the corresponding second bore and into the first bore and has an axial direction defined by the second axis of symmetry and at least partially reinforced by contact with the first bore.

27. The system of claim 22, wherein each adapter ring of the plurality of adapter rings has a third orientation fixation feature, and upon fixing the golf club shaft to the golf club head, the second orientation fixation feature of a first adapter ring of the plurality of adapter rings is mated with the first orientation fixation feature, and the third orientation fixation feature of the first adapter ring mates to either a fourth orientation fixation feature on the golf club shaft of a corresponding shaft tip adapter or the second orientation fixation feature of a second adapter ring.
